(19) United States
(12) Patent Application Publication
(10) Pub. No.: US 2016/0337370 A1
(43) Pub. Date: Nov. 17, 2016

(54) PORTABLE PROFILE ACCESS TOKEN

(71) Applicant: Sony Computer Entertainment America LLC, San Mateo, CA (US)

(72) Inventor: Carter Lipscomb, Oakland, CA (US)

(21) Appl. No.: 14/711,723

(22) Filed: May 13, 2015

(51) Int. Cl. H04L 29/06; G06Q 20/36

(52) U.S. Cl. CPC H04L 63/102; H04L 63/083; G06Q 20/3674; G06Q 2220/00

(57) ABSTRACT

A user's portable device (e.g., wireless mobile device or standalone connector device) can be used to store a profile data set associated with the profile of the user. When the user encounters a base device, the user can transfer his/her profile data set from the portable device to the base device, allowing the base device temporary authorization to download software applications owned by that user's profile to the base device, and also transferring software settings and purchase settings. The user can then trigger the portable device to transfer an authorization token to the base device, authorizing the base device to execute the downloaded software applications, to execute the downloaded software applications according to the user's software settings, and/or to make purchases through the base device using the user's purchase settings. Terminating the connection automatically terminates these authorizations.

### CROSS-REFERENCE TO RELATED APPLICATIONS

The present application is related to U.S. Pat. No. 8,171,536 filed May 23, 2007 and titled “Method and Apparatus for Authenticating Users in a Network,” the disclosure of which is incorporated herein by reference.

### BACKGROUND

1. Field of the Invention

The present invention generally relates to personal profile data. More specifically, the present invention relates to devices for storage and transfer of personal profile data.

2. Description of the Related Art

Typically, multiple hardware devices can run the same software application. However, once a user starts to use an instance of a software application, certain user-adjusted settings and other user profile information is often stored only on the hardware device that the user decided to run the software application on.

Such user profile information can sometimes be difficult and painstaking to recreate. For example, the user profile information may include a saved game file when the software application is a video game. Accurately recreating a saved game file can sometimes be very difficult or impossible if the video game includes elements of randomization, achievements that require other players to help achieve, or special achievements that are available to players only for a limited time (e.g., special holiday items, specific tournament victories). Even when it is possible to recreate a saved game file by replaying a game to the same point as the user was in their previous game, this can take hours, days, or even weeks to achieve.

In the past, when software applications were primarily stored and transferred using physical media (e.g., floppy disks, compact discs, digital video discs, game cartridges), sometimes user profiles would be stored in the physical media alongside the software application, in which case a user could remove the physical media from their hardware device and insert it into a new hardware device, where the user would be able to run the software application using his/her own user profile.

Today, however, more and more software applications are downloaded to hardware devices from networks through an internet connection rather than being purchased in the form of physical media. This is convenient to the user, who can purchase a software application from anywhere instead of needing to go to a store to purchase the physical media on which the software application is stored.

When a user wants to run their software application on a new hardware device, however, it is often difficult to do so, and even more difficult for the user to run their software application using his/her user profile, which may include various software application settings and even payment information. A user might, for example, log in to the new hardware device using his/her login in order to download the software application, but this is not always a desired outcome—for instance, if the new hardware device is a friend's hardware device or a rented hardware device, the user might not want to grant the friend or renter permanent access to the software application and/or to the user's user profile. Often, networks providing software applications limit the number of hardware devices that can access the software application, so allowing a friend's hardware device access to the software application could limit what the user may do with the software application in the future.

There is, therefore, a need in the art for improved software application delivery and user profile systems.

### SUMMARY OF THE PRESENTLY CLAIMED INVENTION

In an exemplary method, a portable device forms a connection between with a nearby base device. The portable device then transmits a profile data set related to a profile of a user to the base device. The profile data set authorizes the base device to download a software application from a network server to a memory of the base device. The portable device then transmits an authorization token to the base device. The authorization token authorizes the base device to execute the software application according to a set of software settings included within the profile data set.

An exemplary system may include a portable device including a portable device memory including a profile data set related to a profile of a user, and a base device including a base device memory and a base device processor. The base device, via execution of instructions stored in the base device memory by the base device processor, may form a connection between the base device and the portable device. The base device may then receive the profile data set from the portable device, wherein the profile data set authorizes the base device to download a software application from a network server to the base device memory. The base device may then receive the software application from the network server. The base device may then receive an authorization token from the portable device, wherein the authorization token authorizes the base device to execute the software application according to a set of software settings contained within the profile data set. The base device may then execute the software application according to the set of software settings.

Various embodiments of the present invention may further include non-transitory computer-readable storage media, having embodied thereon a firewall program executable by a processor to perform methods described herein.

### BRIEF DESCRIPTION OF THE FIGURES

FIG. 1 illustrates an exemplary architecture incorporating an exemplary firewall system with a set of databases.

FIG. 2A illustrates an exemplary data transfer of an exemplary profile data set between an exemplary portable device and an exemplary base device.

FIG. 2B illustrates an exemplary data transfer of an exemplary authorization token between an exemplary portable device and an exemplary base device.

FIG. 3 is a flow diagram illustrating an exemplary data transfers between an exemplary portable device, an exemplary base device, and an exemplary network server from an exemplary network.

FIG. 4 illustrates an exemplary dta transfer between an exemplary network storage of a network and an exemplary local storage of a base device.

FIG. 5 illustrates an exemplary computing system that may be used to implement an embodiment of the present invention.

### DETAILED DESCRIPTION

Embodiments of the present invention allow for a user's portable device (e.g., wireless mobile device or standalone connector device) to be used to store a profile data set associated with the profile of the user. When the user encounters a base device, the user can transfer his/her profile data set from the portable device to the base device, allowing the base device temporary authorization to download software applications owned by that user's profile to the base device, and also transferring software settings and purchase settings. The user can then trigger the portable device to transfer an authorization token to the base device, authorizing the base device to execute the downloaded software applications, to execute the downloaded software applications according to the user's software settings, and/or to make purchases through the base device using the user's purchase settings. Terminating the connection automatically terminates these authorizations.

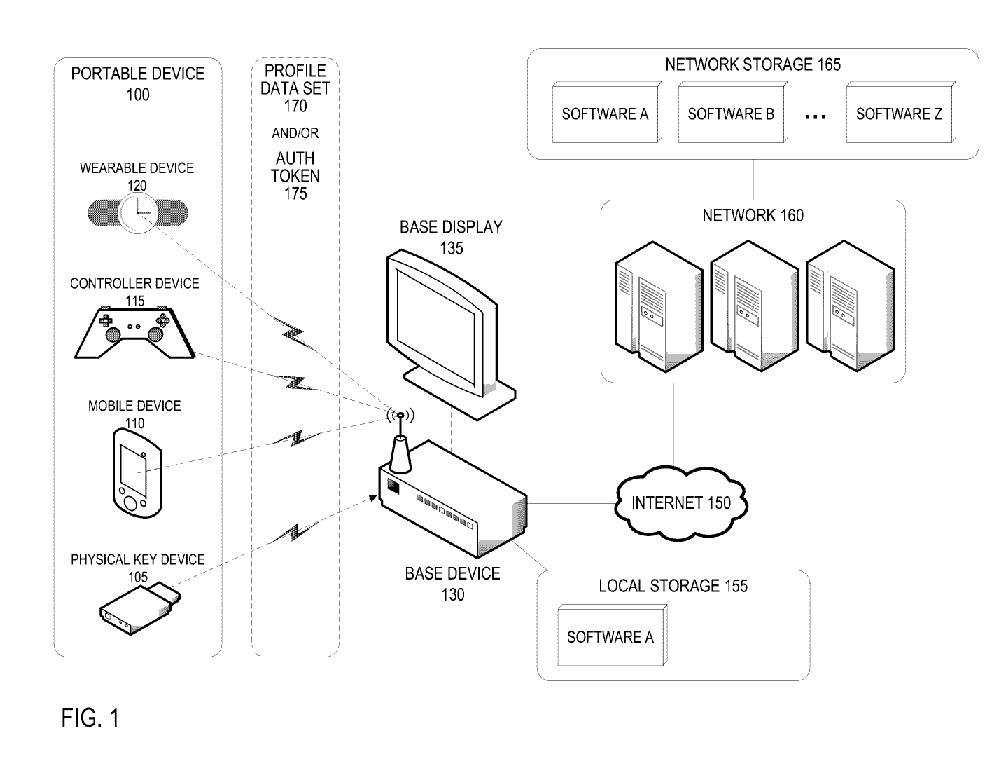

FIG. 1 illustrates an exemplary architecture incorporating an exemplary profile access token system. The exemplary architecture may include a portable device 100, a base device 130, and a network 160. The base device 130 may be communicatively coupled to the network 160 through an internet connection 150.

The portable device 100 may take many forms. For example, the portable device 100 may be a physical “key” device 105, such as a portable storage device with a physical or near-field communication interface such as a Universal Serial Bus (USB) interface or a radio-frequency identification interface. The portable device 100 could also be a mobile device 110, such as a smartphone device, a tablet device, a laptop computer, a wearable device, or a portable media player device. The portable device 100 could also be a controller device 115, such as a controller for a video game console, or a remote control for a television or home entertainment center. The portable device 100 could also be a wearable device 120, such as a device embedded into a watch, bracelet, ring, armband, shoe, necklace, or other article of jewelry or clothing.

The base device 130 may include or be coupled to a base display 135, which may be a computer monitor, a television, or a display incorporated into the body of base device 130. The base display 135 may be a cathode ray tube (CRT) display, a liquid crystal display (LCD), a light emitting diode (LED) display, an organic LED (OLED) display, a polymer light emitting device (PLED) display, an electroluminescent (EL) display, an electrophoretic display, an electrochromic display, an electrowetting display, a gas plasma display, a fiber plasma display, or another type of display.

The base device 130 may include or be coupled to a local storage 155. The local storage 155 may include one or more computer readable and/or writeable mediums such hard drives, floppy diskettes, Writeable CD Roms, Writeable DVDs, Writeable High Definition DVDs, Writeable Blu-ray discs, flash memories, hard drives, writeable optical discs, film-based data storage mechanisms, or similar computer readable and/or writeable mediums.

The local storage 155 can be used to store data that may include software applications that may be executed by the base device 130. The local storage 155 is illustrated in FIG. 1 as including Software A, though this should be understood to be illustrative rather than limiting. The network storage 165 can, in some instances, store any number of software applications, and may store more than 26 (i.e., A-Z) software applications. Software A may be stored at local storage 155 because it was received from the network 160. For example, network 160 may have copied Software A from network storage 165 and transmitted the copy of Software A to the base device 130, which stored the copy of Software A in local storage 155.

The base device 130 may be any type of computing device. For example, the base device 130 may be a smartphone, a tablet, a laptop computer, a desktop computer, a gaming console, a smart television, a home entertainment system, a wearable device, a portable networked media player, a networked appliance, a network device, a structured query language (SQL) server, a web front-end server, a central administration server, an index server, a database server, an application server, a gateway server, a broker server, an active directory server, a terminal server, a virtualization services server, a virtualized server, a file server, a print server, an email server, a security server, a connection server, a search server, a license server, a “blade” server, a virtual machine, a “thin” client, a Redundant Arrays of Independent Disks (RAID) array, or any other type of computing device.

The base device 130 may include a variety of components, such as a processor, a memory, a display, a keyboard, a mouse, a touchscreen, a battery, a non-volatile storage system, a hard drive, a basic input/output system (BIOS), a floppy disk reader, a floppy disk writer, a compact disc (CD) reader, a CD writer, a digital versatile disc (DVD) reader, a DVD writer, a high-definition digital versatile disc (HD-DVD) reader, an HD-DVD writer, a Blu-Ray disc reader, a Blu-Ray disc writer, a holographic disc reader, a holographic disc writer, a wired and/or wireless communication interface (e.g, a USB port module, a FireWire port module, a Lightning port module, a Thunderbolt port module, a Wi-Fi connection module, a 3G/4G/LTE cellular connection module, a Bluetooth connection module, a Bluetooth low energy connection module, a, Bluetooth Smart connection module, a near field communication module, a radio wave communications module), and other components. The processor of the base device 130 may execute an operating system and a variety of other software elements.

The network 160 may include one or more communicatively coupled network servers. These network servers may then be linked to the internet 150, and able to connect to the base device 130 through their connection to the internet 150.

Each network server of the network 160 may be any type of computing device. For example, the network server of the network 160 may be a smartphone, a tablet, a laptop computer, a desktop computer, a gaming console, a smart television, a home entertainment system, a wearable device, a portable networked media player, a networked appliance, a network device, a structured query language (SQL) server, a web front-end server, a central administration server, an index server, a database server, an application server, a gateway server, a broker server, an active directory server, a terminal server, a virtualization services server, a virtualized server, a file server, a print server, an email server, a security server, a connection server, a search server, a license server, a “blade” server, a virtual machine, a “thin” client, a Redundant Arrays of Independent Disks (RAID) array, or any other type of computing device.

Each network server of the network 160 may include a variety of components, such as a processor, a memory, a display, a keyboard, a mouse, a touchscreen, a battery, a non-volatile storage system, a hard drive, a basic input/output system (BIOS), a floppy disk reader, a floppy disk writer, a compact disc (CD) reader, a CD writer, a digital versatile disc (DVD) reader, a DVD writer, a high-definition digital versatile disc (HD-DVD) reader, an HD-DVD writer, a Blu-Ray disc reader, a Blu-Ray disc writer, a holographic disc reader, a holographic disc writer, a wired and/or wireless communication interface (e.g, a USB port module, a FireWire port module, a Lightning port module, a Thunderbolt port module, a Wi-Fi connection module, a 3G/4G/LTE cellular connection module, a Bluetooth connection module, a Bluetooth low energy connection module, a, Bluetooth Smart connection module, a near field communication module, a radio wave communications module), and other components. The processor of the network server of the network 160 may execute an operating system and a variety of other software elements.

One or more network servers of the network 160 may include or be coupled to a network storage 165. The network storage 165 may thus be a local storage of one or more network servers of the network 160, or it may be a distributed storage system spread throughout the network servers of network 160. The network storage 165 may include one or more computer readable and/or writeable mediums such hard drives, floppy diskettes, Writeable CD Roms, Writeable DVDs, Writeable High Definition DVDs, Writeable Blu-ray discs, flash memories, hard drives, writeable optical discs, film-based data storage mechanisms, or similar computer readable and/or writeable mediums.

The network storage 165 can be used to store data that may include software applications that may be executed by the base device 130. The network storage 165 is illustrated in FIG. 1 as including Software A through Software Z, though this labeling should be understood to be illustrative rather than limiting. The network storage 165 can, in some instances, store more than 26 (i.e., A-Z) software applications.

The portable device 100 can directly connect to the base device 130 in a physical manner (e.g, wired connection or port interface) or in a local wireless manner (e.g., near field communication, bluetooth connection, bluetooth low energy connection, bluetooth smart connection, Wi-Fi direct connection, infrared communication, ultrasonic communication, subsonic communication, active radio frequency identification, passive radio frequency identification, or another method of wireless connection). This may include the portable device 100 entering into a local area network (LAN) or wireless local area network (WLAN) with the base device 130. In some embodiments, the portable device 100 can also connect to the base device 130 over a connection to the internet 150 (e.g., through an Ethernet connection, a Wi-Fi connection, an Edge smartphone data network connection, a third-generation “3G” smartphone data network connection, a fourth-generation “4G” smartphone data network connection, a Long-Term Evolution “LTE” smartphone data network connection, or some other type of smartphone data network connection).

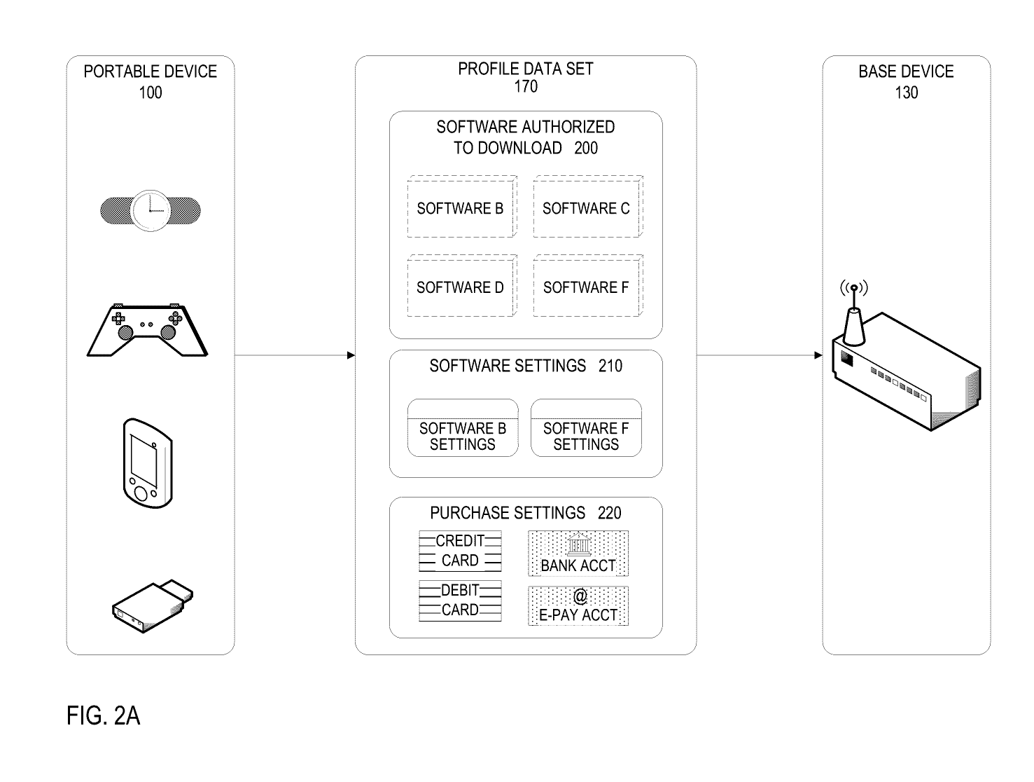

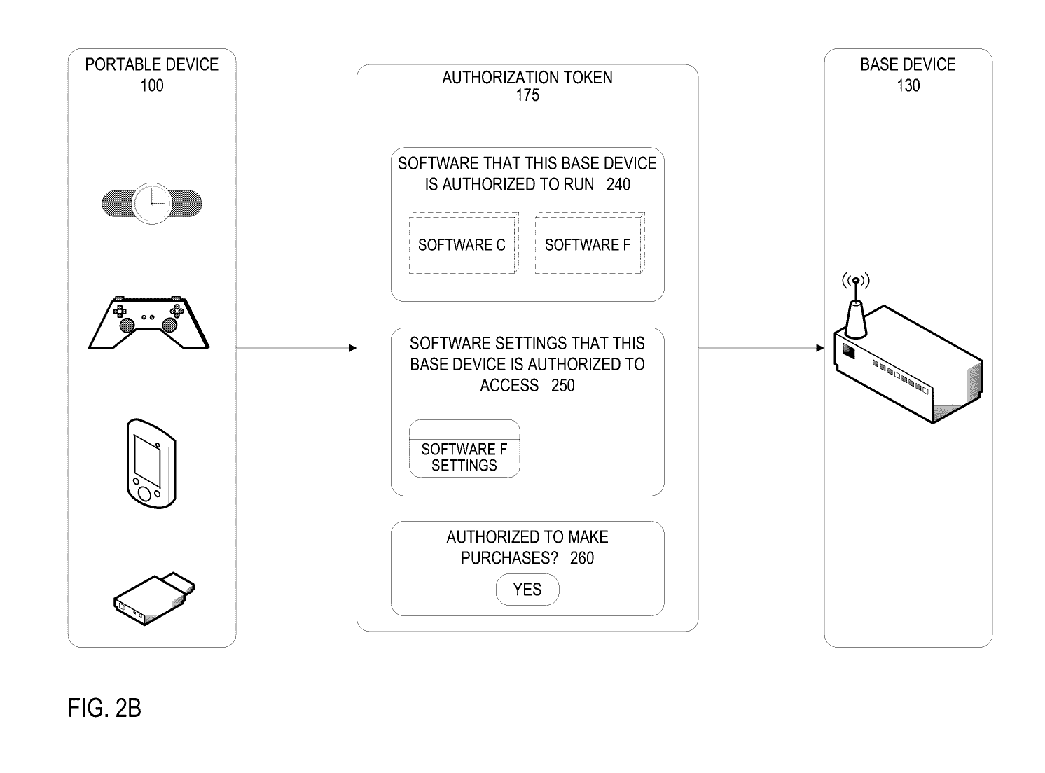

The connection between the portable device 100 and the base device 130 can be used to transfer data from the portable device 100 to the base device 130. For example, the connection can be used to transmit a user profile data set 170 from the portable device 100 to the base device 130 (see FIG. 2A). The connection can also be used to transmit an authorization token from the portable device 100 to the base device 130 (see FIG. 2B).

FIG. 2A illustrates an exemplary data transfer of an exemplary profile data set 170 between an exemplary portable device 100 and an exemplary base device 130. The exemplary profile data set 170 is tied to the profile of a user of the portable device 100. The exemplary profile data set 170 includes a “software authorized to download” dataset 200, a “software settings” dataset 210, and “purchase settings” dataset 220. It should be understood that a profile data set 170 may include more, fewer, or different data sets in other embodiments.

A “software authorized to download” dataset 200 is a list of software applications that are authorized to download to a base device 130 according to the profile of the user. This list could include, for example, software applications that the user has purchased and/or software applications that the user has downloaded while they were available to download for free. The exemplary profile data set 170 of FIG. 2A includes Software B, Software C, Software D, and Software F in its “software authorized to download” dataset 200. Thus, a base device 130 receiving the exemplary profile data set 170 from the exemplary portable device 100 could download Software B, Software C, Software D, and Software F.

A “software settings” dataset 210 can also be included in the profile data set 170. This dataset 210 can include settings pertaining to software applications that the user has run before. These software settings can include anything that the user has customized about their copy of a particular piece of software. For example, these software settings can include customization of options, network connection settings, saved game files if the software is a video game, or achievements obtained if the software is a video game, or multiplayer settings if the software is a video game, or a music/media library if the software is a music/media software application, or a set of subscribed podcasts or radio/television stations or websites or newspapers if the software is a subscription software application, or a “continue” point if the software is a media player software application, or in-app purchases (“IAP”) or downloadable content (“DLC”) if the software allows for purchases, or a purchase history if the software is an e-commerce application, and other types of software application settings. The exemplary profile data set 170 of FIG. 2A includes Software B Settings and Software F Settings in its “software settings” dataset 210, meaning that the user has run Software B and Software F and has customized his/her copy of Software B and Software F. Accordingly, base device 130 can obtain the “software settings” dataset 210 along with the profile data set 170 in some embodiments.

The “software settings” dataset 210 may be secured from unwanted access, such as by using an encryption for the entire dataset 210 and/or for individual software settings (e.g., Software B Settings and Software F Settings may be individually encrypted). The authorization token 175 (see FIG. 2B) may then include an encryption key or another means to decrypt or obtain information for some or all of the “software settings” dataset 210.

The “software authorized to download” dataset 200 may also be secured from unwanted access, such as by using an encryption for the entire dataset 200. The authorization token 175 (see FIG. 2B) may then include an encryption key or another means to decrypt or obtain information for some or all of the “software authorized to download” dataset 200.

In some embodiments, the profile data set 170 does not include the “software settings” dataset 210. In some embodiments, the “software settings” dataset 210, or a subset thereof, is instead included in the authorization token 175 (see FIG. 2B). In some embodiments, the “software settings” dataset 210, or a subset thereof, is instead included in the network storage 165, where the software settings for an application are downloaded when the software applications is downloaded (after the base device 130 is authorized to download the software applications by the profile data set 170) or when running the software applications is authorized (via authorization token 175). In some embodiments, the “software settings” dataset 210, or a subset thereof, is instead included in a second base device (not shown but that is otherwise similar to base device 130), where the software settings for an application are downloaded when the software applications is downloaded (after the base device 130 is authorized to download the software applications by the profile data set 170) or when running the software applications is authorized (via authorization token 175).

A “purchase settings” dataset 220 can also be included in the profile data set 170. The “purchase settings” dataset 220 can include, for example, information about the user's credit cards, debit cards, bank accounts, or electronic “e-payment” accounts from which payments may be authorized (e.g., PayPal, Apple Pay, Apple iTunes, Google Wallet, Amazon Wallet, PlayStation Now, XBOX Marketplace). The “purchase settings” dataset 220 may be encrypted in some embodiments of the profile data set 170, to be decrypted later using a decryption key supplied through the authorization token 175 (see FIG. 2B). The “purchase settings” dataset 220 can be used to enable a user to purchase software applications or make other purchases to be credited toward the user's profile but from any base device 130.

FIG. 2B illustrates an exemplary data transfer of an exemplary authorization token 175 between an exemplary portable device 100 and an exemplary base device 130. The exemplary authorization token 175 is tied to the profile of a user of the portable device 100. The exemplary authorization token 175 includes a “software that this base device is authorized to run” dataset 240, a “software settings that this base device is authorized to access” dataset 250, and a “authorized to make purchases?” dataset 260. It should be understood that a profile data authorization token 175 may include more, fewer, or different data sets in other embodiments.

The “software that this base device is authorized to run” dataset 240 is a list of software applications that a base device 130 that has connected with a portable device 100 is authorized to run. This may be a subset of the “software authorized to download” dataset 200 provided as part of the profile data set 170.

The “software settings that this base device is authorized to access” 250 is a list of software settings that the base device 130 that has connected with the portable device 100 is authorized to access. This may be a subset of the “software settings” dataset 210 provided as part of the profile data set 170. In some embodiments, the “software settings that this base device is authorized to access” dataset 250 may include decryption keys or other methods to access otherwise inaccessible software settings from the “software settings” dataset 210. In some embodiments, the profile data set 170 might not include the “software settings” dataset 210, and instead, the authorization token simply includes the relevant software settings along with the “software settings that this base device is authorized to access” dataset 250. The “software settings that this base device is authorized to access” 250 dataset may also include a decryption key or other means to access one or more software settings from the “software settings” dataset 210 that have been encrypted or otherwise stored securely.

The “authorized to make purchases?” dataset 260 can be a simple “yes” or “no” dataset that signifies if purchases on behalf of the user are to be allowed from the base device 130. The “authorized to make purchases?” dataset 260 can also include limitations, such as based on the type of content (e.g., a restriction that only educational software applications may be purchased) or based on an amount (e.g., a restriction that individual purchases may not exceed $50 and/or total purchases may not exceed $200) or based on a time period (e.g., a restriction of one purchase per day) or some combination thereof (e.g., a restriction of one educational software application purchase per day not exceeding $50). The “authorized to make purchases?” dataset 260 dataset may also include a decryption key or other means to access one or more payment information sets from the “purchase settings” dataset 220 that have been encrypted or otherwise stored securely.

An exemplary situation that can help illustrate the usefulness of the portable device 100 and the communications discussed in FIG. 2A and FIG. 2B relates to video games. For example, in one embodiment, the software applications stored in network storage 165 and local storage 155 may be video games, and the base device 130 may be a video game console. An exemplary user could bring his/her portable device 100 (tied to his/her user account) to a friend's house. The user could connect the portable device 100 to, for example, a friend's video game console (i.e., a base device 130). As discussed in FIG. 2A, the portable device 100 could then transmit the profile data set 170 to the friend's video game console (i.e., base device 130) the authorize the friend's video game console (i.e., base device 130) to start downloading a set of games (“software authorized to download” 200) from the network 160. Once the user and the friend are ready to play a game, the user can transmit an authorization token 175 to the friend's video game console (i.e., base device 130) to authorize the playing of the user's favorite games on the friend's game console (i.e., base device 130) (“software that this base device is authorized to run” 240). The user could choose not to authorize the playing of some games even if he/she has authorized the friend's video game console (i.e., base device 130) to download them (i.e., SOFTWARE B and SOFTWARE D were present in “software authorized to download” 200 but are missing from “software that this base device is authorized to run” 240). The user's authorization token 175 can also authorize the friend's video game console (i.e., base device 130) to access the user's software settings (e.g., saved game files) for particular games of the games that the friend's video game console (i.e., base device 130) has been authorized to run 240 (i.e., through “software settings that this base device is authorized to access” 250). The authorization token 175 might, for example, grant the friend's video game console (i.e., base device 130) a decryption key for the software settings for “Software F” but not for “Software B,” even though both were uploaded to the friend's video game console (i.e., base device 130) as part of the profile data set 170.

If the user and the friend then decide to purchase a new software application (e.g., a new game), then they may do so through the friend's video game console (i.e., base device 130) using the user's account (i.e., the user, not the friend, pays for the new software application) so that the new software application is tied to the user's profile (i.e., the user, not the friend, ultimately owns the new software application). This may be done according to the payment options in the “purchase settings” dataset 220, so long as the “authorized to make purchases?” dataset 260 of the authorization token 175 authorizes purchases to be made.

Once the exemplary user goes back home, the user can take the portable device 100 with him/her. If the portable device 100 uses a physical/wired connection, or a local wireless connection, this means that the connection between the portable device 100 and the friend's video game console (i.e., base device 130) is automatically terminated. Once this connection is terminated, the friend's video game console (i.e., base device 130) loses its authorization to download software applications/games (granted through “software authorized to download” dataset 200 of the profile data set 170), loses its authorization to run software applications/games (granted through “software that this base device is authorized to run” dataset 240 of the authorization token 175), loses its authorization to access the user's software settings (granted through “software settings that this base device is authorized to access” dataset 250 of the authorization token 175), and loses its authorization to purchase new software applications/games (granted through “authorized to make purchases?” dataset 260 of the authorization token 175). The friend's video game console (i.e., base device 130) may also lose the software applications/games that it downloaded from the network 160 under the authorization of the user's portable device 100 (granted through “software authorized to download” 200 of the profile data set 170), or it may keep them stored (but unplayable until re-authorized through a new profile data set 170) to prepare for a future gaming session. The friend's video game console (i.e., base device 130) may also lose the software settings 210 that it received from the profile data set 170 from the user's portable device 100, or it may keep them stored (but inaccessible until re-authorized through a new authorization token 175) to prepare for a future gaming session.

The video game software application and video game console base device 130 example should be viewed as illustrative rather than limiting. The software applications can be any type of software applications, and the base console 130 may be any type of computerized system. For example, the software could be applications to execute on a vehicle system computer (i.e., base console 130) of a friend's car or of a rental car. The software could be applications to execute on a smartphone, tablet, laptop, or desktop (i.e., base console 130) that is not the user's traditional/previous smartphone, tablet, laptop, or desktop (i.e., base console 130).

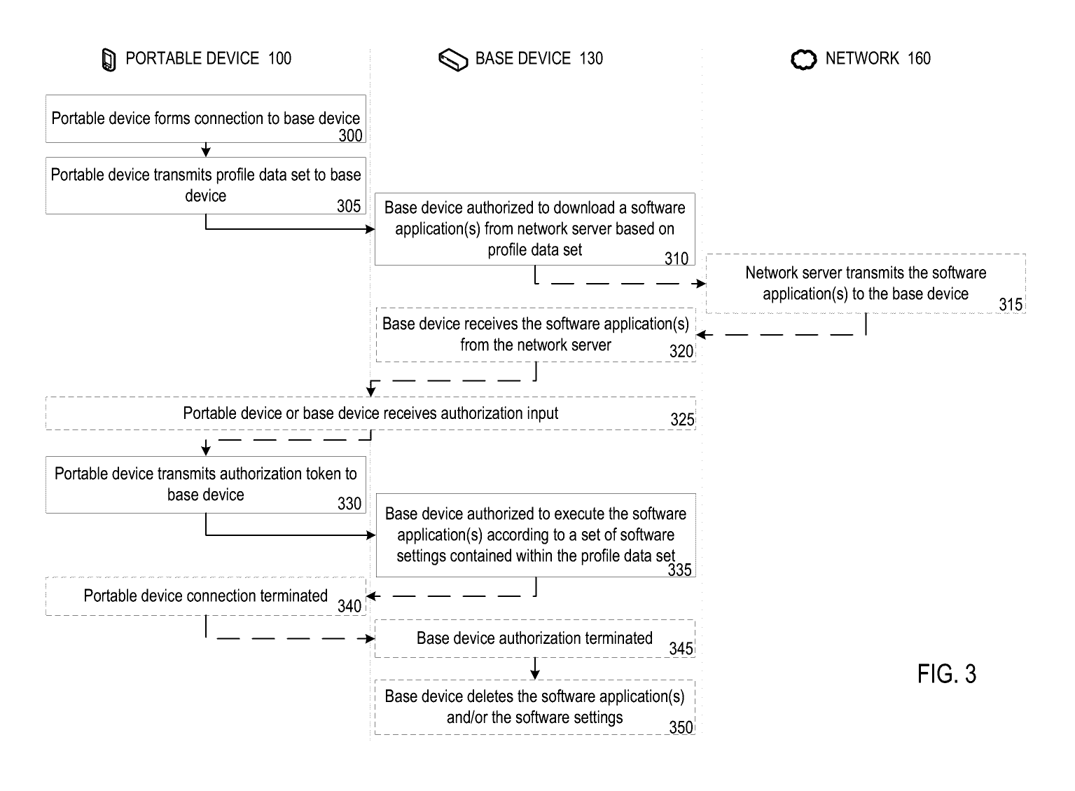

FIG. 3 is a flow diagram illustrating an exemplary data transfers between an exemplary portable device 100, an exemplary base device 130, and an exemplary network server from an exemplary network 160. The exemplary data transfer process begins with the exemplary portable device 100 forming a connection to the exemplary base device 130 (step 300).

The portable device 100 then transmits a profile data set 170 to the base device 130 (step 305). The base device 130 may then be authorized to download a software application from the network server based on the “software authorized to download” dataset 200 of the profile data set 170 (step 310). The network server of the network 160 may then transmit a copy of the software application (e.g., from the network storage 165) to the base device 130 (step 315). The base device 130 may then receive the software application from the network server of the network 160 (step 320) and store it (e.g., in local storage 155).

The portable device 100 and/or base device 130 may then optionally receive an authorization input (step 325) which may be a simple button push or switch in a mechanical or graphical user interface. The authorization input might include a security prompt, such as a password, a passcode, a user account login, a payment information, a Public Key Infrastructure (PKI) certificate, an OAuth token, a two-step-verification input, a social media account identification, or a biometric scan (e.g., thumbprint recognition, iris recognition, voice recognition, facial recognition). For example, the user could enter a password at the base device 130 in order to trigger the portable device 100 to transmit the authorization token 175, or the user could perform a fingerprint scan at the portable device 100 in order to trigger the portable device 100 to transmit the authorization token 175. Alternately, both of these can be required in order to achieve two-factor authentication in the authentication input. The portable device 100 then transmits the authorization token 175 to the base device 130 (step 330). Once the base device 130 receives the authorization token 175, the base device 130 may then be authorized to execute the software application (authorization to run based on “software that this base device is authorized to run” dataset 240) according to a set of software settings 200 (authorization to run according to software settings 200 based on “software settings that this base device is authorized to access” dataset 250) contained within the profile data set 350 (step 335).

The connection between the portable device 100 and the base device 130 may then be terminated (step 340), either manually (e.g., through button, switch, or other graphical or mechanical user interface) or automatically (e.g., by physical unplugging the portable device 100 from a physical/wired connection to the base device 130, or by moving the portable device 100 far enough away that a local wireless connection stops functioning, or via a timer). Once the connection between the portable device 100 and the base device 130 is terminated, the various authorizations granted to the base device 130 are also terminated (step 345). That is, the base device 130 is no longer authorized to download the software application, to run the software application, or the access the software settings and/or run the software application according to the software settings for that software application. In some embodiments, the base device 130 may also be required to delete any copies of the of the software application(s) that were downloaded from the network 160 under the authorization of the portable device 100 (step 350). In some embodiments, the base device 130 may also be required to delete any copies of any software settings that were obtained from the portable device and/or network storage 165 (step 350).

While the flow diagram in FIG. 3 shows a particular order of operations performed by certain embodiments of the invention, it should be understood that such order is exemplary (e.g., alternative embodiments can perform the operations in a different order, combine certain operations, overlap certain operations, etc.).

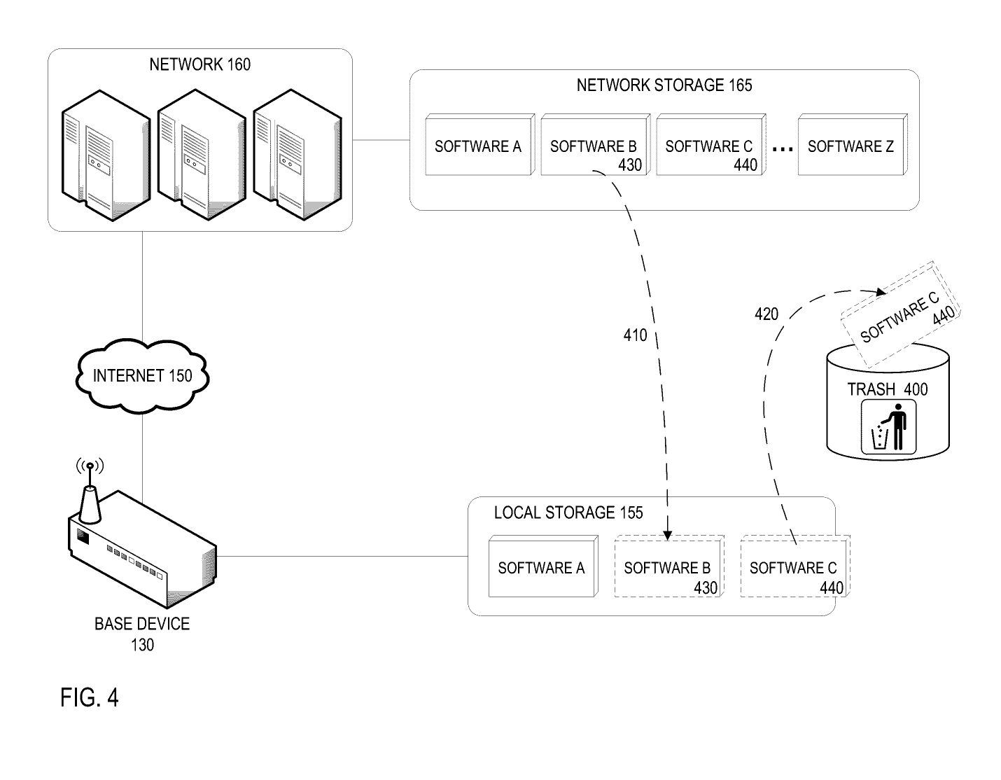

FIG. 4 illustrates an exemplary data transfer between an exemplary network storage 165 of a network 160 and an exemplary local storage 155 of a base device 130. In particular, FIG. 4 illustrates a base device 130 downloading a software application “SOFTWARE B” 430 from the network storage 165 of the network 160 to the local storage 155 of the base device 130 (transfer 410). The download of software application “SOFTWARE B” 430 characterized by transfer 410 should be understood to be transferred using the internet connection 150, and is illustrated using a line drawn alongside the internet connection 150 for clarity rather than to indicate some other form of transfer.

The download of software application “SOFTWARE B” 430 may be, for example, prompted by a portable device 100 (not shown), if the portable device 100 connected to the base device 130 and transferred, to the base device 130, a profile data set 170 that listed software application “SOFTWARE B” 430 in the “Software authorized to download” dataset 200 of the profile data set 170.

Sometimes, a local storage 155 of a base device 130 can be limited in size, and might not have enough free space to accommodate a download of software application “SOFTWARE B” 430. In such a situation, the base device 130 can delete one or more applications or assign the one or more applications a “trash” state 400 (e.g., transfer 420). For example, FIG. 4 illustrates that local storage 155 is too small to fit existing software application “SOFTWARE A,” incoming software application “SOFTWARE B” 430, and existing software application “SOFTWARE C” 440. As a result, the base device 130 decides to delete software application “SOFTWARE C” 440, or assign it to a “trash” state 400. Assigning of a “trash” state 400 may include compressing the data of the trashed software application 440, deleting “less important” portions of a software application (e.g., video cut scenes of a video game software application), or moving the trashed software application 440 to a special “zone” of network storage 165 or another local or network storage. Deleting a software application or assigning it to a “trash” state 400 may not be a final, irreversible deletion, because the base device 130 may in some instances be able to re-download the trashed software application 440 from the network storage 165. Further, the local storage 155 may still keep software settings pertaining to a trashed software application 440 that has been deleted or assigned a “trash” state 400, so that once the trashed software application 440 is re-downloaded, the software settings remain.

In some embodiments, the user of the base device 130 and/or of the portable device 100 may be able adjust a set of “trash settings” to determine which, if any, software applications stored in local storage 155 may be deleted to make room for new software applications authorized for download by the portable device 100. For example, a “trash setting” may indicate that the base device 130 should delete or “trash” 400 the least-used software application to make room for a new software application. Alternately, a “trash setting” may indicate that the base device 130 should delete or “trash” 400 the oldest software application to make room for a new software application. Alternately, a “trash setting” may indicate that the base device 130 should delete or “trash” 400 the most recently added software application to make room for a new software application. Alternately, a “trash setting” may indicate that the base device 130 should delete or “trash” 400 the least recently used software application to make room for a new software application.

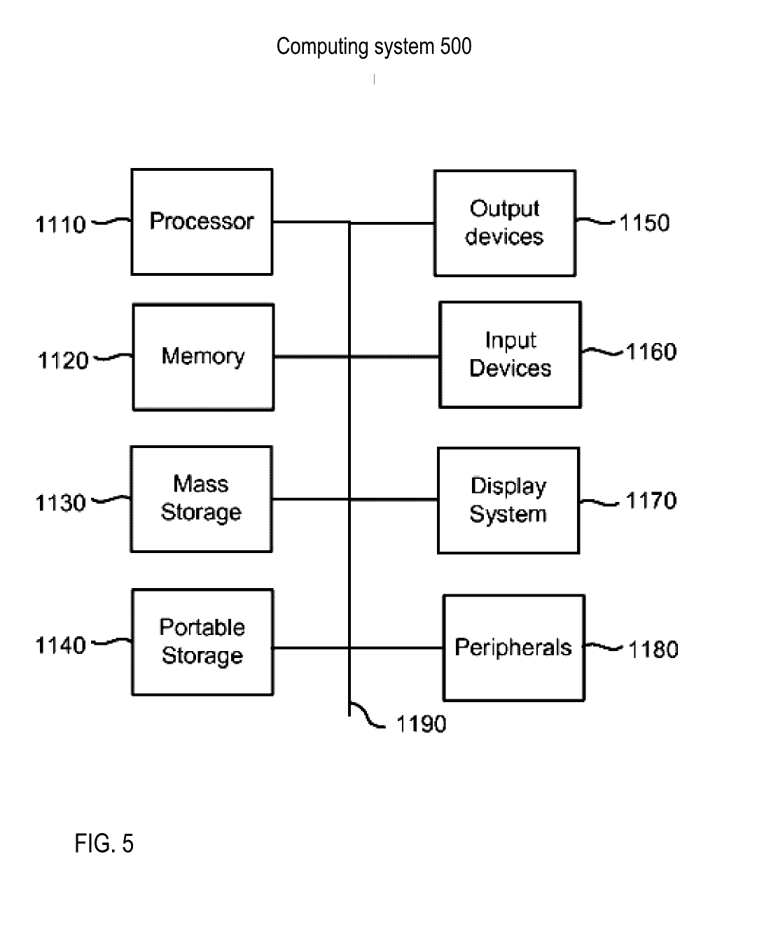

FIG. 5 illustrates an exemplary computing system 500 that may be used to implement an embodiment of the present invention. For example, exemplary computing system 500 may be an embodiment of portable device 100, base device 130, or of a network server of network 160. The computing system 500 of FIG. 5 includes one or more processors 510 and memory 520. Main memory 520 stores, in part, instructions and data for execution by processor 510. Main memory 520 can store the executable code when in operation. The system 500 of FIG. 5 further includes a mass storage device 530, portable storage medium drive(s) 540, output devices 550, user input devices 560, a graphics display 570, and peripheral devices 580.

The components shown in FIG. 5 are depicted as being connected via a single bus 590. However, the components may be connected through one or more data transport means. For example, processor unit 510 and main memory 520 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present invention for purposes of loading that software into main memory 520.

Portable storage device 540 operates in conjunction with a portable non-volatile storage medium, such as a floppy disk, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 570 may include a liquid crystal display (LCD) or other suitable display device. Display system 570 receives textual and graphical information, and processes the information for output to the display device.

Peripherals 580 may include any type of computer support device to add additional functionality to the computer system. For example, peripheral device(s) 580 may include a modem or a router.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method of operating a portable device, the method comprising:
forming a connection between the portable device with a nearby base device;
transmitting a profile data set related to a profile of a user from the portable device to the base device, wherein the profile data set authorizes the base device to download a software application from a network server to a memory of the base device; and
transmitting an authorization token from the portable device to the base device, wherein the authorization token authorizes the base device to execute the software application according to a set of software settings included within the profile data set.

2. The method of claim 1, further comprising terminating the connection between the portable device and the base device, wherein terminating the connection terminates the base device's authorization to execute the software application according to the set of software settings included within the profile data set.

3. The method of claim 1, further comprising terminating the connection between the portable device and the base device, wherein terminating the connection terminates the base device's authorization to execute the software application.

4. The method of claim 1, further comprising terminating the connection between the portable device and the base device, wherein terminating the connection deletes the software application from the base device.

5. The method of claim 1, further comprising receiving an authorization input prior to the portable device transmitting the authorization token to the base device, the authorization input received from one of the portable device or the base device.

6. The method of claim 5, wherein the authorization input includes a security response, the security response including at least one of a password, a passcode, a user account login, a payment information, a Public Key Infrastructure (PKI) certificate, an OAuth token, a two-step-verification input, a social media account identification, or a biometric scan.

7. The method of claim 1, wherein the authorization token further authorizes the base device to make purchases according to a set of purchase settings included within the profile data set, the purchases tied to the profile of the user.

8. The method of claim 1, further comprising terminating the connection between the portable device and the base device, but wherein the base device retains authorization to download a software application from the network server.

9. The method of claim 1, further comprising adjusting a trash setting, the trash setting indicating a category of software application, the category of software application including one or more secondary software applications, the one or more secondary software applications stored in the memory of the base device, the one or more secondary software applications to be deleted to make room for the downloading of the software application.

10. A system comprising:
a portable device including a portable device memory, wherein the portable device memory includes a profile data set related to a profile of a user; and
a base device including a base device memory and a base device processor, wherein execution of instructions stored in the base device memory by the base device processor:
forms a connection between the base device and the portable device,
receives the profile data set from the portable device, wherein the profile data set authorizes the base device to download a software application from a network server to the base device memory,
receives the software application from the network server,
receives an authorization token from the portable device, wherein the authorization token authorizes the base device to execute the software application according to a set of software settings included within the profile data set, and
executes the software application according to the set of software settings.

11. The system of claim 10, wherein execution of instructions stored in the base device memory by the base device processor further terminates the base device's authorization to execute the software application according to the set of software settings included within the profile data set upon termination of the connection between the portable device and the base device.

12. The system of claim 10, wherein execution of instructions stored in the base device memory by the base device processor further terminates the base device's authorization to execute the software application upon termination of the connection between the portable device and the base device.

13. The system of claim 10, wherein execution of instructions stored in the base device memory by the base device processor further deletes the software application from the base device upon termination of the connection between the portable device and the base device.

14. The system of claim 10, wherein execution of instructions stored in the base device memory by the base device processor further transmits an authorization input to the portable device prior to receiving the authorization token from the portable device.

15. The system of claim 14, wherein the authorization input includes a security response, the security prompt response including at least one of a password, a passcode, a user account login, a payment information, a Public Key Infrastructure (PKI) certificate, an OAuth token, a two-step-verification input, a social media account identification, or a biometric scan.

16. The system of claim 10, wherein execution of instructions stored in the base device memory by the base device processor further purchases a second software application from the network according to a set of purchase settings included within the profile data set, the purchases tied to the profile of the user.

17. The system of claim 10, wherein execution of instructions stored in the base device memory by the base device processor further retains authorization to download a software application from the network server upon termination of the connection between the portable device and the base device.

18. The system of claim 10, further comprising automatically deleting one or more secondary software applications, the one or more secondary software applications stored in the base device memory, the one or more secondary software applications to be deleted to make room for the downloading of the software application.

19. A non-transitory computer-readable storage medium, having embodied thereon a program executable by a processor to perform a method for providing on-demand wireless services, the method comprising:
forming a connection between the portable device with a nearby base device;
transmitting a profile data set related to a profile of a user from the portable device to the base device, wherein the profile data set authorizes the base device to download a software application from a network server; and
transmitting an authorization token from the portable device to the base device, wherein the authorization token authorizes the base device to execute the software application according to a set of software settings included within the profile data set.
